(19) United States
(12) Patent Application Publication
(10) Pub. No.: US 2006/0060639 A1
(43) Pub. Date: Mar. 23, 2006

(54) Doped contact formations

(76) Inventors: Tiffany A. Byrne, Chandler, AZ (US); Edward L. Martin, Chandler, AZ (US); Carl L. Deppisch, Chandler, AZ (US); Daewoong Suh, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/946,711

(22) Filed: Sep. 21, 2004

(51) Int. Cl. B23K 31/00

(52) U.S. Cl. 228/248.1

(57) ABSTRACT

According to one aspect of the invention, a contact formation and an electronic assembly incorporating the contact formation are provided. The contact formation may include a low temperature solder material and a plurality of dopant material particles within the solder material. The dopant material may include at least one of an insoluble metal, an intermetallic compound, and an oxide. The low temperature solder material may have a first liquidus temperature, and the contact formation may have a second liquidus temperature. The second liquidus temperature may be approximately the same as the first liquidus temperature.

### BACKGROUND OF THE INVENTION

1. Field of the Invention

Embodiments of this invention relate to a doped contact formation and an electronic assembly incorporating the doped contact formation.

2. Discussion of Related Art

Integrated circuits, such as ferroelectric polymer memories, are formed on semiconductor wafers. The wafers are then sawed (or “singulated” or “diced”) into microelectronic dice, also known as semiconductor chips, with each chip carrying a respective integrated circuit. Each semiconductor chip is then mounted to a package, or carrier, substrate, thereby forming a semiconductor package. Often the packages are then mounted to a printed circuit board, such as a motherboard, which may then be installed into a computing system.

The package substrates provide structural integrity to the semiconductor chips and are used to connect the integrated circuits electrically to the motherboard. Ball Grid Array (BGA) solder ball contact formations are formed on one side of the package substrate and are soldered to the motherboard. This process typically requires two “reflow” processes.

The polymers used in the polymer memories are very sensitive to extreme temperatures, and if subjected to temperatures of 125° C. or more (such as 140° C.), depending on the particular polymer used, the polymer memories may be permanently damaged. Therefore, low temperature solders, with liquidus (or melting) temperatures typically below 125° C., are used in the solder balls that connect the packages to the printed circuit board so that the packages can be attached without the danger of damaging the polymer memories.

The polymer memories typically have operating temperatures between 50° C. and 80° C. Because of the low melting temperatures of the solder used, the solder balls are highly susceptible to “creep” and fatigue while subjected to the operating temperatures of the polymer memories, thus severely reducing the reliability of the solder joints. Additionally, because the solders used often include indium, the solder balls have significantly lowered shear and tensile strength that limits the ability if the solder balls to withstand mechanical stress. Furthermore, multiple reflows can also accelerate solder joint failure through microstructural coarsening and intermetallic growth.

### BRIEF DESCRIPTION OF THE DRAWINGS

Embodiments of the invention are described by way of example with reference to the accompanying drawings, wherein:

FIG. 1A is a perspective view of a semiconductor package, including a package substrate and a microelectronic die;

FIG. 2 is a bottom view of the semiconductor package with a plurality of contact formations connected to the package substrate;

FIG. 3A is a cross-sectional side view of the semiconductor package as illustrated in FIG. 2;

FIG. 3B is a schematic view of a microstructure of one of the contact formations on Detail A in FIG. 3A;

FIG. 4 is a flow chart illustrated a heating process to attach the contact formations to the semiconductor package;

FIG. 5A is a cross-sectional side view of the semiconductor package similar to FIG. 3A;

FIG. 5B is a schematic view of the microstructure of the contact formations on Detail B in FIG. 5A;

FIG. 6 is a perspective view of the semiconductor package with the contact formations attached thereto;

FIG. 7 is a perspective view of a printed circuit board with the semiconductor package attached thereto; and

FIG. 8 is a block diagram of a computing system.

### DETAILED DESCRIPTION OF THE INVENTION

In the following description, various aspects of the present invention will be described, and various details will be set forth in order to provide a thorough understanding of the present invention. However, it will apparent to those skilled in the art that the present invention may be practiced with only some or all aspects of the present invention, and the present invention may be practiced without the specific details. In other instances, well-known features are omitted or simplified in order not to obscure the present invention.

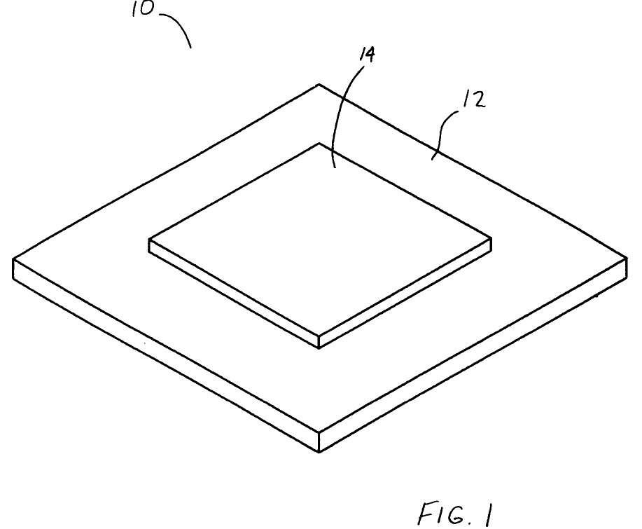

It should be understood that FIGS. 1-8 are merely illustrative and may not be drawn to scale.

FIG. 1A to FIG. 8 illustrate a contact formation and an electronic assembly incorporating the contact formation in accordance with an embodiment of the present invention. The contact formation may include a low temperature solder material and a plurality of dopant material particles within the solder material. The dopant material may include at least one of an insoluble metal, an intermetallic compound, and an oxide. The low temperature solder material may have a first liquidus temperature, and the contact formation may have a second liquidus temperature. The second liquidus temperature may be approximately the same as the first liquidus temperature.

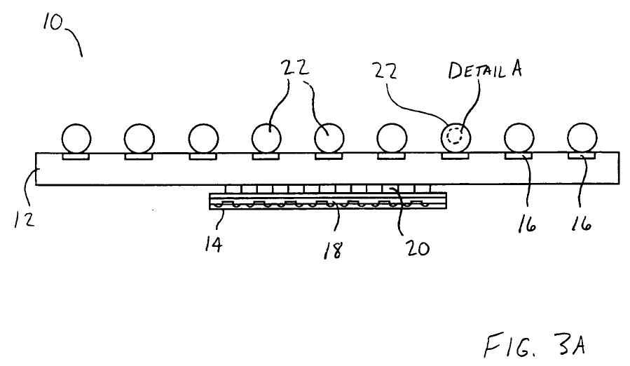

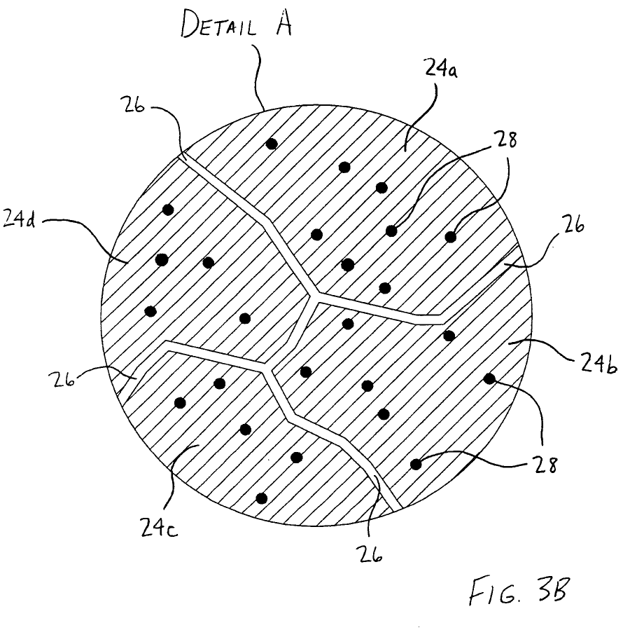

FIGS. 1, 2, and 3A illustrate a semiconductor package 10. The semiconductor package 10 may include a package substrate 12 and a microelectronic die 14. The package substrate 12 may be square with, for example, side lengths of approximately 3 centimeters and a thickness of approximately 3 millimeters. The package substrate 12 may include a plurality of alternating conducting and insulating layers therein, as is commonly understood in the art. The package substrate 12 may have the microelectronic die 14 mounted to a top surface thereof and, referring specifically to FIG. 3A, the package substrate 12 may have a plurality of bonding pads 16 formed on a bottom (or opposing) surface thereof. The bonding pads 16 may be made of copper, or other conductive material, and may be formed using electroplating. Although not illustrated in detail the bonding pads 16 may have, for example, a thickness of approximately 0.25 millimeters and a width of approximately 0.8 millimeters.

Referring again to FIG. 1, the microelectronic die 14 may be mounted to a central portion of the top surface of the package substrate 12, and may have, for example, side lengths of approximately 1.5 centimeters and a thickness of approximately 1,000 microns. Although not illustrated in detail, the microelectronic die 14 may be attached to the package substrate 12 using wire bonds, or other contact formations. As illustrated in FIG. 3A, the microelectronic die 14 may include an integrated circuit, with multiple transistors and capacitors, formed therein and a plurality of alternating insulating and conducting layers, as is commonly understood in the art. The microelectronic die 14 is illustrated in what is commonly known as a “flip-chip” configuration.

The integrated circuit 18 may be a polymer device, such as a ferroelectric polymer memory, which may further include a plurality of alternating conducting lines and layers of polymeric material that jointly form a plurality of “cells.” The polymeric layers may be made of polyvinylidine fluoride. It should be noted the other integrated circuits, such as microprocessors, may also be used and may require processing temperatures below 125° C.

Other useful ferroelectric polymers are typically fluorinated hydrocarbons having a high concentration of carbon atoms with only one fluoride atom attached. Other ferroelectric polymers include polyfluoroethylene, poly(2,3-difluoro-1,4-benzene), poly(2,3-difluoro-1,4-benzyl ether), poly(1,2-difluoroethyl), and the like, the copolymers, and the mixtures of the above-mentioned polymers.

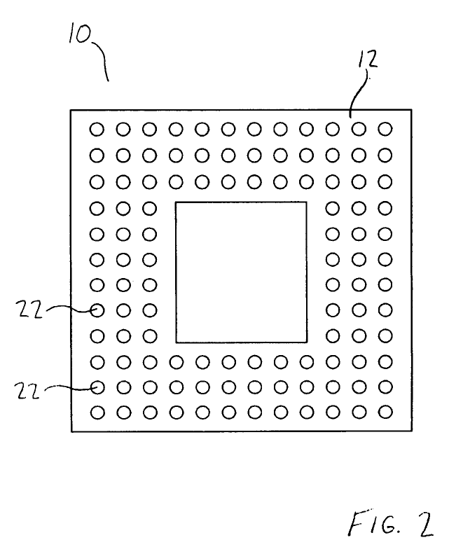

As illustrated in FIGS. 2 and 3A, a plurality of contact formations 22, such as Ball Grid Array (BGA) solder balls, may then be placed on the lower surface of the package substrate 12, in direct contact with the bonding pads 16. The contact formations 22 may be, for example, spherical in shape with diameters of between 0.3 millimeters and 0.889 millimeters before assembly reflow.

FIG. 3B illustrates a microstructure of one of the contact formations 22 of FIG. 3A. As illustrated, the microstructure includes grains 24a-24d of solder material, grain boundaries 26 between the grains 24a-24d, and dopant particles 28 dispersed homogenously throughout the microstructure. As is commonly understood in the art each of the grains 24a-24d represents a piece of the contact formation 22 with a uniform, or aligned lattice structure. The grain boundaries 26 lie within the microstructure at points where the lattice structure becomes misaligned.

The dopant material particles 28 may include insoluble metals, intermetallic compounds, and/or oxides. Useful insoluble metals may include copper (Cu), silver (Ag), and zinc (Zn). The intermetallic compounds may be copper tin (CuSn). The oxides may include silver oxide (Ag₂O₃), zirconium oxide (ZrO₂), and thorium oxide (ThO₂). Mixtures of the above dopant materials may also be used. The dopant material particles 28 may be in the contact formations 22 in concentrations ranging from 1 to 1,000 parts per million (ppm), preferably about 600 ppm. The concentration of the dopant material particles 28 may be sufficient to prevent creep of the contact formation 22 and improve the mechanical strength of the contact formation 22 without increasing the liquidus temperature of the contact formation 22. The dopant material particles 28 may have diameters of between 50 nanometers and 1 micrometer.

The dopant material particles 28 may be added to the contact formations 22, using known processes, during the formation of the contact formations 22, as is commonly understood in the art.

The solder materials used in the contact formations 22 may be low temperature solders having luquidus temperatures well below 183° C., or preferably below 140° C. More preferably, the solder material has a liquidus temperature below 125° C. Examples of useful low temperature solder materials include tin indium (SnIn), tin indium silver (SnInAg), bismuth indium (BiIn), and tin bismuth lead (SnBiPb). Tin indium solder may include 48 percent tin and 52 percent indium and have a liquidus temperature of approximately 118° C. Tin indium silver may have a liquidus temperature of approximately 113° C. Bismuth indium may have a liquidus temperature of approximately 109° C. Tin bismuth lead may have a liquidus temperature of approximately 100° C.

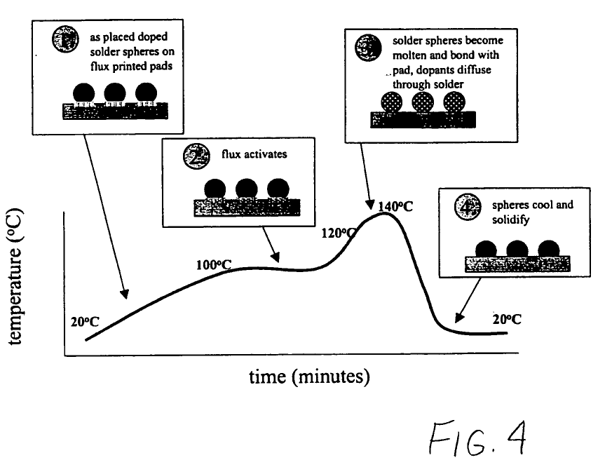

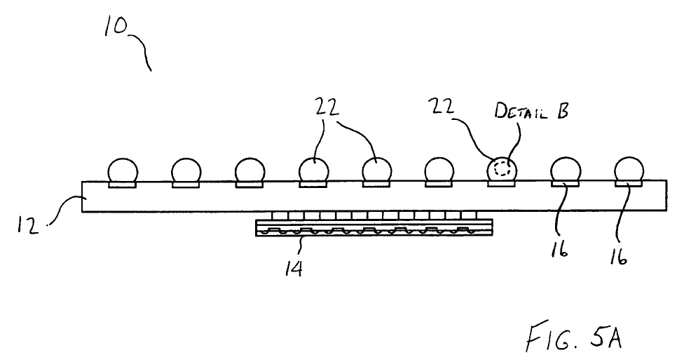

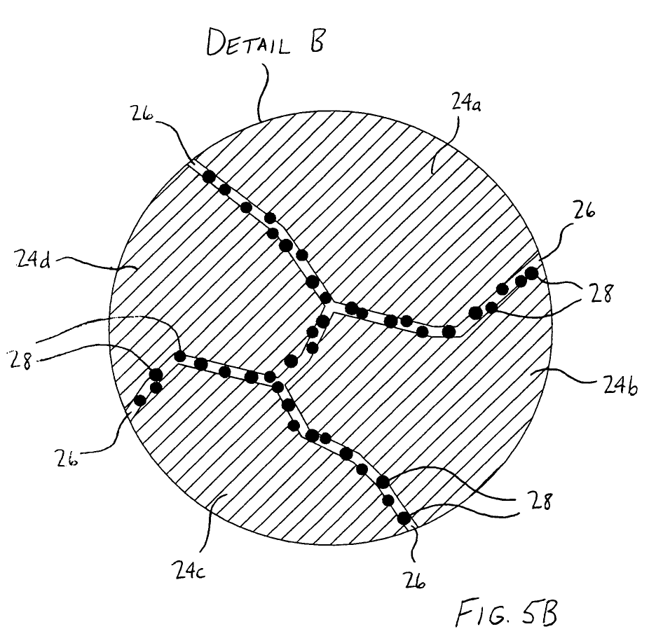

As illustrated in FIGS. 4 and 5A, the semiconductor package 10, in particular the contact formations 22, may then undergo a heating process to secure the contact formations 22 to the bonding pads 16. The semiconductor package 10 may be brought from room temperature (approximately 20° C.) up to about 100° C. over a time period of approximately 90 seconds. The temperature of the semiconductor package 10 may be maintained approximately between 100° C. and 120° C. for approximately 90 seconds. The temperature may then be raised between 120° C. and 140° C. over a period of approximately 60 seconds. The temperature of the semiconductor package 10 may then be lowered back to room temperature over a period of approximately 90 seconds.

The temperatures discussed above may vary depending on the particular solder material used and the thermal mass of the device, as well as the particular polymer used in the polymer memory. The particular solder material may be chosen such that the solder may be bonded to the package substrate at a temperature that will not damage the particular polymer used in the polymer memory. As is commonly understood in the art, flux which has been deposited on the bonding pads 16 typically activates at approximately 100° C. At 140° C., the solder and the contact formations 22, particularly the low temperature solder materials used in the present invention, have become molten and bonded to the bonding pads 16.

It should be noted that the dopant material particles 28 of the present invention do not appreciably increase the liquidus temperatures of the solder materials because of the relatively low concentrations of the dopant particles used. Therefore, the liquidus temperature of the contact formation may be approximately the same as the liquidus temperature of the solder material used. The melting temperatures of the contact formations 22 may thus remain below the temperature at which the polymer memories may be damaged.

Referring again to FIG. 5A, as the semiconductor package 10 is returned to room temperature, the contact formations 22 may cool and re-solidify and become attached to the bonding pads 16.

Referring to FIG. 5B, after the contact formations 22 have undergone the heating process described above, the dopant material particles 28 may have migrated within the microstructure of the contact formations 22. The dopant material particles 28 may now be heavily concentrated at the grain boundaries 26 between the grains 24a-24d of the microstructure of the contact formations 22. The dopant material particles 28 may now be essentially “locked” between the grains 24a-24d along the grain boundaries 28.

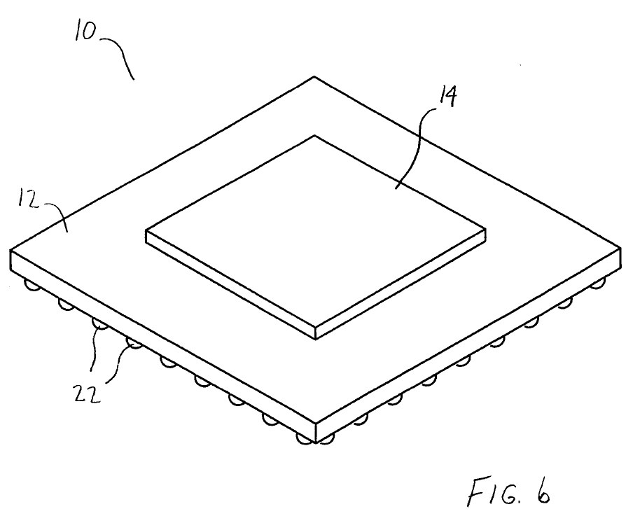

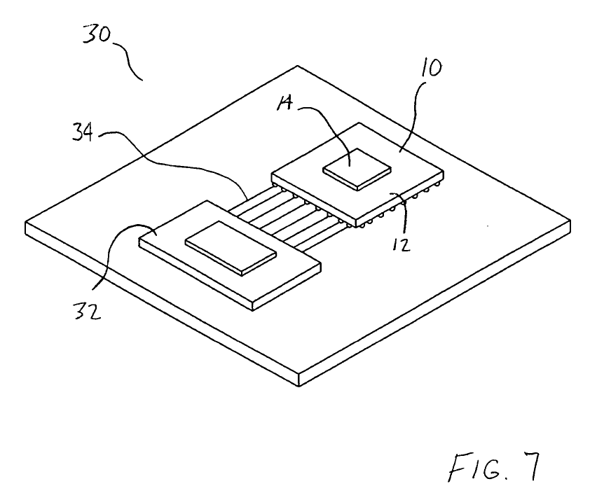

As illustrated in FIGS. 6 and 7, the semiconductor package 10 with the contact formations 22 attached to a lower surface thereof, may then be attached to a printed circuit board 30 to form an electronic assembly. Referring specially to FIG. 7, the printed circuit board 30, or motherboard, may be a large substrate having a plurality of sockets for securing and providing electric signals to various packages, microelectronic dice, and other electronic devices 32, in addition to the semiconductor package 10. As is commonly understood in the art, the printed circuit board 30 may also include conductive traces 34 to electrically connect the various devices that have been attached thereto. To attach the semiconductor package 10 to the printed circuit board 30, the package 10, particularly the contact formations 22, may be heated to the liquidus temperature of the particular solder material used (or the liquidus temperature of the contact formation), causing the contact formations 22 to reflow. The contact formations 22 may then be connected to the printed circuit board 30.

Thus the electronic assembly may include at least the package substrate 12, the printed circuit board 30, and the microelectronic die 14, or first, second, and third substrate respectively.

In use, the printed circuit board 30 may be installed into a computing system. Electric signals, such as input/output (IO) signals, may then be sent from the integrated circuit 18 within the die 14 through the package substrate 12, and into the computing system through the printed circuit board 30. Power and ground signals may also be provided to the die 14. The computing system may send similar, or different, signals back to the integrated circuit 18 within the die 14 through the printed circuit board 30 and the package substrate 12.

As the integrated circuit 18 is used the temperature of the semiconductor package 10 may increase from room temperature up to between approximately 50° C. and 80° C. Referring again to FIG. 5B, the dopant material particles 28 along the grain boundaries 26 of the microstructure of the contact formations 22 essentially “lock” the grains 24A-24D into place thereby decreasing the likelihood that the contact formations 22 would undergo creep and fatigue stresses that would lead to solder joint failure.

One advantage is that the dopant material particles improve the strength and creep resistance of the low temperature solder joint through such mechanisms as Orowan dislocation bowing, precipitation hardening, grain boundary pinning (Zener mechanism), and modifying intermetallic compound formation. Another advantage is that a more reliable solder joint is provided without increasing the liquidus temperature of the contact formations thereby protecting the temperature sensitive polymers used within the polymer memory device. A further advantage is that the liquidus temperature of the solder material is not appreciably increased. Thus, the contact formations may be heated to reflow without damaging the integrated circuit.

Other embodiments may use solder paste, which may be made of the same materials, instead of the solder balls. The solder paste may be doped “in-situ” by blending a solder powder with a dopant material powder (and flux) during manufacture. Such a mixture will not react until heated during a reflow process when the dopants will be dispersed throughout the solder paste, thereby resulting in an in-situ doping process.

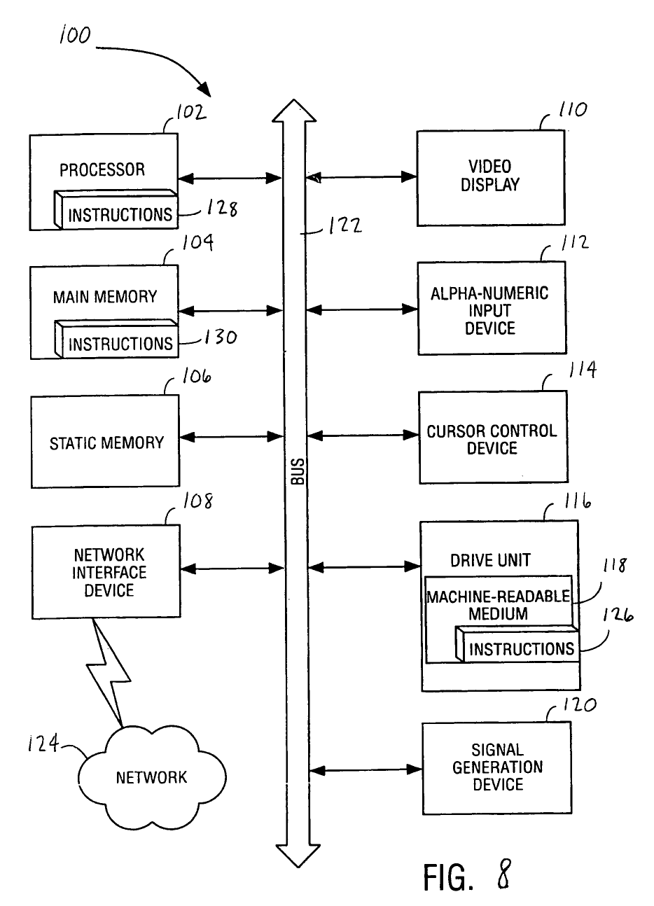

FIG. 8 illustrates a computing system 100 into which the various microelectronic dice, semiconductor packages, and printed circuit boards described above may be installed. The computing system 100 may include a processor 102, a main memory 104, a static memory 106, a network interface device 108, a video display device 110, and alpha-numeric input device 112, a cursor control device 114, a drive unit 116 including a machine-readable medium 118, and a signal generation device 120. All of the components of the computing system 110 may be interconnected by a bus 122. The computing system 110 may be connected to a network 124 through the network interface device 108.

The machine-readable medium 118 may include a set of instructions 126, which may be partially transferred to the processor 102 and the main memory 104 through the bus 122. The processor 102 and the main memory 104 may also have separate internal sets of instructions 128 and 130.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A contact formation comprising:
a solder material; and
a plurality of dopant material particles within the solder material, the dopant material including at least one of an insoluble metal, an intermetallic compound, and an oxide.

2. The contact formation of claim 1, wherein the solder material has a first liquidus temperature and the contact formation has a second liquidus temperature, the second liquidus temperature being approximately the same as the first liquidus temperature.

3. The contact formation of claim 2, wherein the first and second liquidus temperatures are below 183 degrees C.

4. The contact formation of claim 3, wherein the first and second liquidus temperatures are below 140 degrees C.

5. The contact formation of claim 4, wherein the dopant material includes an insoluble metal, the insoluble metal including at least one of copper, silver, and zinc.

6. The contact formation of claim 4, wherein the dopant material includes an intermetallic compound.

7. The contact formation of claim 6, wherein the intermetallic compound is copper tin.

8. The contact formation of claim 4, wherein the dopant material includes an oxide, the oxide including at least one of silver oxide, zirconium oxide, and thorium oxide.

9. The contact formation of claim 4, wherein the solder material includes at least one of tin indium, tin indium silver, bismuth indium, and tin bismuth lead.

10. The contact formation of claim 9, wherein the solder material includes approximately 48 percent tin and 52 percent indium.

11. An electronic assembly comprising:
a first substrate having an integrated circuit formed therein;
a second substrate; and
a plurality of contact formations interconnecting the first and second substrates and being electrically connected to the integrated circuit, the contact formations including a solder material and a plurality of dopant material particles within the solder material, the dopant including at least one of an insoluble metal, an intermetallic compound, and an oxide.

12. The electronic assembly of claim 11, wherein the solder material has a first liquidus temperature and the contact formation has a second liquidus temperature, the second liquidus temperature being approximately the same as the first liquidus temperature.

13. The electronic assembly of claim 12, wherein the first and second liquidus temperatures are below 183 degrees C.

14. The electronic assembly of claim 13, wherein the first and second liquidus temperatures are below 140 degrees C.

15. The electronic assembly of claim 14, wherein the dopant material includes an insoluble metal, the insoluble metal including at least one of copper, silver, and zinc.

16. The electronic assembly of claim 14, wherein the dopant material includes an intermetallic compound.

17. The electronic assembly of claim 16, wherein the intermetallic compound is copper tin.

18. The electronic assembly of claim 14, wherein the dopant material includes an oxide, the oxide including at least one of silver oxide, zirconium oxide, and thorium oxide.

19. The electronic assembly of claim 14, wherein the solder material includes at least one of tin indium, tin indium silver, bismuth indium, and tin bismuth lead.

20. The electronic assembly of claim 14, further comprising a third substrate, the first substrate being mounted sequentially through the third substrate and the contact formations to the second substrate.

21. The electronic assembly of claim 20, wherein the first substrate is a microelectronic die, the second substrate is a printed circuit board, and the third substrate is a package substrate including plurality of alternating conducting and insulating layers formed therein.

22. The electronic assembly of claim 21, wherein the integrated circuit is a polymer memory and further comprising a microprocessor attached to the printed circuit board.

23. The electronic assembly of claim 22, further comprising a computing system, the printed circuit board being electrically connected to the computing system.

24. A method constructing an electronic assembly comprising:
doping a solder material contact formation with a plurality of dopant material particles, the dopant material being selected from the group consisting of an insoluble metal, an intermetallic compound, and an oxide; and
connecting the contact formation to a first substrate such that the contact formation is electrically connected to an integrated circuit.

25. The method of claim 24, further comprising connecting the contact formation to a second substrate.

26. The method of claim 25, wherein said connection of the contact formation to the first substrate is through a third substrate, the integrated circuit being formed within the first substrate.

27. The method of claim 26, wherein the first substrate is a microelectronic die, the second substrate is a printed circuit board, and the third substrate is a package substrate including plurality of alternating conducting and insulating layers formed therein.

28. The method of claim 27, wherein the low temperature solder material has a microstructure with a plurality of grains and grain boundaries between the grains, the dopant material particles being substantially homogeneously distributed throughout the low temperature solder material before the contact formation is heated to the second liquidus temperature and being concentrated at the grain boundaries after the contact formation is heated to the second liquidus temperature.

29. The method of claim 28, wherein the low temperature solder material has a first liquidus temperature and the contact formation has a second liquidus temperature, the second liquidus temperature being approximately the same as the first liquidus temperature.
